(19) United States
(12) Patent Application Publication
(10) Pub. No.: US 2008/0301421 A1
(43) Pub. Date: Dec. 4, 2008

(54) Method of speeding up execution of repeatable commands and microcontroller able to speed up execution of repeatable commands

(76) Inventors: Wen-Chi Hsu, Lugang Township (TW); Zhi-Wei Yang, Tainan City (TW); Yu-Kuang Wu, Jhongli City (TW); Jia-Jou Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,879

(22) Filed: Mar. 25, 2008

(30) Foreign Application Priority Data
Jun. 1, 2007 (TW) 96119849

(51) Int. Cl. G06F 9/22

(52) U.S. Cl. 712/241; 712/E09.004

(57) ABSTRACT

A method to speed up the execution of repeatable commands and a microcontroller able to speed up the execution of repeatable commands are disclosed. When the microcontroller is to execute repeatable commands in a program, it temporarily stores repeatable commands to a storage unit. If the execution of the repeatable command loop continues, then the repeatable command loop is retrieved from the storage unit and executed at higher clock cycle frequency. At the start and end of the repeatable command loop are respectively defined by a starting point and an end point for determining whether the repeatable command loop should continue to execute. The microcontroller thereby speeds up the execution of the repeatable command and the performance thereof.

### BACKGROUND OF THE INVENTION

1. Field of the Invention

The invention generally relates to a microcontroller, and more particularly to a method of speeding up the execution of repeatable commands and a microcontroller able to speed up the execution of repeatable commands.

2. Description of the Related Art

A commercial available microcontroller has main functions such as command retrieve, command decoding, command execution and data access. As the technology level of manufacturing microcontroller increases, clock cycle is not the bottleneck of manufacturing command execution circuits. Instead, the main factor affecting the performance of the microcontroller is the retrieval of program commands.

When the microcontroller executes commands, it retrieves commands from a command storage device. At present, the most commonly used command storage device is flash memory and EEPROM. 45 ns˜70 ns of clock speed is typical for the above storage device and is insufficient to match the clock cycle of the microcontroller, thereby deteriorating the performance of the microcontroller.

Even though some approaches such as pre-storing command, diverse detection have been provided to increase the performance of the microcontroller, still they only achieve subtle improvement because of the limitation by the complicated configuration of such microcontroller.

### SUMMARY OF THE INVENTION

Repeatable commands of a program are temporarily stored in a command register with a fast access speed. When the program is executed to continue the repeatable commands, the stored commands are retrieved and run with higher clock frequency, so as to speed up the execution of the repeatable command and the performance of the microcontroller.

In order to achieve the above and other objectives, a microcontroller able to speed up the execution of repeatable commands includes a command memory used to store a program in order to provide a program command, wherein the program includes at least a repeatable command loop; a command register used to temporarily store the repeatable command loop; a command selecting unit connected to the command memory and the command register so that the command memory retrieves the program command or retrieves the repeatable command loop from the command register; a frequency selecting unit used to switch between a first frequency and a second frequency, wherein the second frequency is higher than the first frequency; and a command processor connected to the command register, the command selecting unit, and the frequency selecting unit. The command processor copies the repeatable command loop to the command register so as to control the command selecting unit to retrieve the program commands or the repeatable command loop. When the command processor has to repeatedly execute the repeatable command loop, the command selecting unit is made to retrieve the repeatable command loop from the command register, and the frequency selecting unit provides the second frequency to process the repeatable command loop. When the command processor has no need to repeatedly execute the repeatable command loop, the command selecting unit retrieves the program command from the command memory so that the frequency selecting unit provides the first frequency to process the program command.

The invention further provides a microcontroller able to speed up the execution of repeatable commands. The microcontroller include a command memory used to store a program in order to provide a program command, wherein the program includes at least a repeatable command loop; a data memory, including a universal data memory used to store data and a scratchpad RAM used to store data or temporarily store the repeatable command loop; a command selecting unit connected to the command memory and the command register so that the command memory can retrieve the program command or so that the repeatable command loop can be retrieved from the command register; a frequency selecting unit used to select one of a first frequency and a second frequency, wherein the second frequency is higher than the first frequency; and a command processor connected to the scratchpad RAM, the command selecting unit and the frequency selecting unit so that the repeatable command loop can be copied to the scratchpad RAM, thereby controlling the command selecting unit to receive the program command or the repeatable command loop. When the command processor needs to repeatedly execute the repeatable command loop, the command selecting unit retrieves the repeatable command loop from the scratchpad RAM and control the frequency selecting unit to provide the second frequency to process the repeatable command loop. When the command processor has no need to repeatedly execute the repeatable command loop, the command selecting unit retrieves the program command from the command memory and controls the frequency selecting unit to provide a first frequency to process the program command.

The invention further provides a method of speeding up the execution of repeatable commands. The method includes steps of (a) retrieving a program command for a program from a command memory, wherein the program includes at least one repeatable command loop; (b) processing the program command and detect if it is the starting point of the repeatable command loop; (c) if the command is at the starting point of the repeatable command loop, then copy the command to a command register, wherein the command register's data storage speed is faster than the command memory's data storage speed; (d) the command process retrieves a subsequent program command; (e) processing the subsequent program command and determine whether the subsequent command is at an end point of the repeatable command loop or not; if the subsequent program command is not at the end point of the repeatable command loop, then copy the subsequent command and go back to step d; (f) if the subsequent program command is at the end point of the repeatable command loop, then determine whether the execution of the repeatable command loop continues or not; (g) if the execution of the repeatable loop will continue, then copy the program command to the command register and switching the clock cycle frequency from the first frequency to the second frequency, wherein the second frequency is higher than the first frequency; and (h) retrieving the repeatable command loop from the command register and executing the repeatable command loop at the second frequency.

To provide a further understanding of present invention, the following detailed description illustrates embodiments and examples of present invention, this detailed descriptions are provided for illustrative purpose only and are not meant to limit the scope of present invention.

### BRIEF DESCRIPTION OF THE DRAWINGS

FIG. 1 is a block diagram of a microcontroller according to a first preferred embodiment of present invention;

FIG. 2 is a schematic view of a program commands according to one embodiment of present invention;

FIG. 3 is a block diagram of a microcontroller according to a second embodiment of present invention;

FIG. 4 is a flow chart of a method of speeding up the execution of repeatable commands according to one embodiment of present invention.

### DETAILED DESCRIPTION OF THE EMBODIMENTS

Wherever possible in the following description, like reference numerals will refer to like elements and parts unless otherwise illustrated.

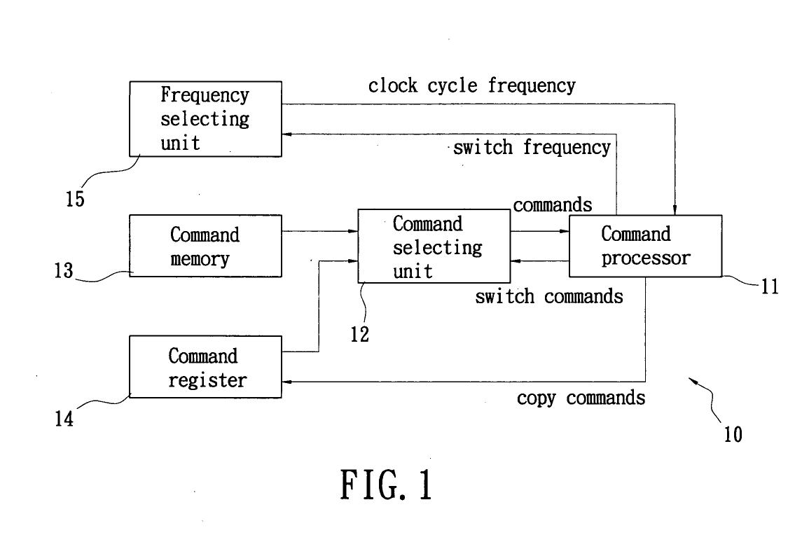

FIG. 1 is a block diagram of a microcontroller according to a first preferred embodiment of present invention. Microcontroller 10 is able to speed up the execution of repeatable commands, and includes a command processor 11, a command selecting unit 12, a command memory 13, a command register 14 and a frequency selecting unit 15. Frequency selecting unit 15 is controlled by command processor 11 to provide a first frequency and a second frequency as clock cycle frequency; wherein the second frequency is higher than the first frequency. Command memory 13 is used to store a program command which is processed by command processor 11. The program includes at least a repeatable command loop which is typically the subprogram of the program that routinely runs repeatedly in background. When command processor 11 processes the repeatable command loop, commands in the repeatable command loop are copied to command register 14. Command selecting unit 12 is respectively connected to command memory 13 and command register 14. The program commands are retrieved from command memory 13 and processed by command processor 11. Alternatively, the repeatable command loop is retrieved from command register 14 and processed by command processor 11. The access speed of command register 14 is faster than command memory 13.

Command processor 11 is connected respectively to frequency selecting unit 15, command selecting unit 12, and command register 14. Command processor 11 controls via command selecting unit 12 to retrieve program commands of command memory 13 for processing, if it is a repeatable command loop that is being processed, then the repeatable command loop is copied to command register 14 while being processed. And when the last command of the repeatable command loop is processed; it is detected whether execution of the repeatable command loop shall start again. If the execution of the repeatable command loop shall start again then frequency selecting unit 15 switches from the first frequency to the second frequency, and command selecting unit 12 retrieves the repeatable command loop from command register 14 so as to process the repeatable command loop at the second frequency.

Command processor 11 detects the starting and end points of the repeatable command loop according to a special command in the program.

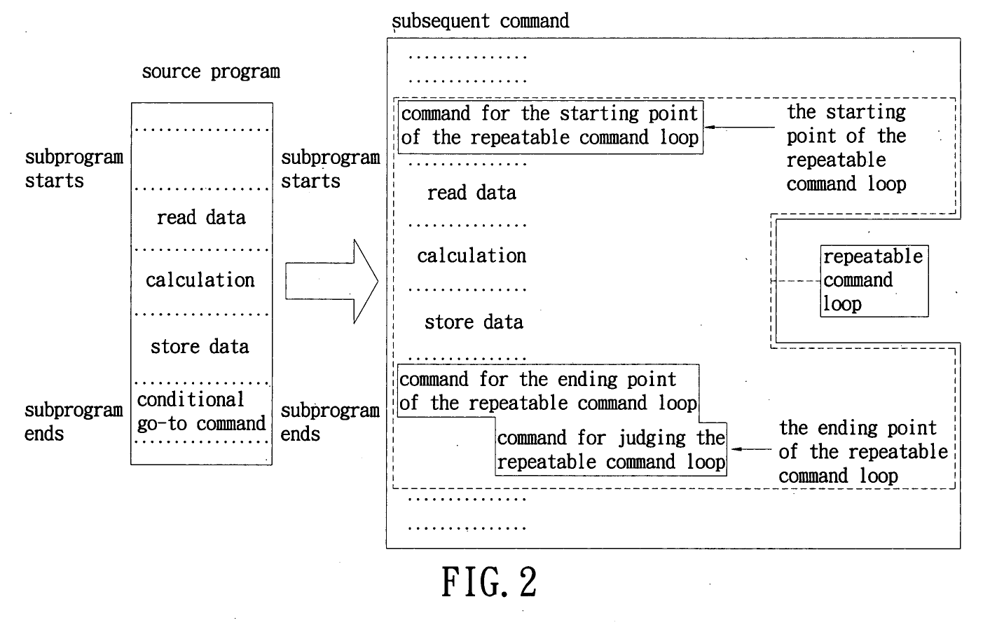

FIG. 2 is a schematic view of a program commands according to one embodiment of the present invention. For example, a source program contains a subprogram that performs repeating calculation. The subprogram contains data which is read, calculated and stored back to the memory. At the end of the calculation, there is a conditional go-to command, if the condition of repeating command is met then the process jumps back to the start of subprogram, if the condition is not met then the process continues with the source program.

The repeatable command loop includes a starting point and an end point. The starting point is defined at the start of the repeatable command loop and used for the command processor to identify a starting position of the repeatable command loop. The end point is defined at the end of the repeatable command loop and used for the command processor to identify an end position of the repeatable command loop.

The start of the subprogram is defined as a starting point of a repeatable command loop, in order to notify command processor 11 that this is where the repeatable command loop starts, so as to start recording command code to command register 14; an end of the subprogram is defined as an end point of a repeatable command loop. Furthermore, the end point of the repeatable command loop includes a repeatable command loop assessment command. The repeatable command loop assessment command has a go-to command condition which is defined by condition at the end of the subprogram. The end point of the repeatable command loop notify command processor 11 of the repeatable command loop's ending time, and at this moment it determines if the execution of the repeatable command loop continues. If the go-to command condition of the repeatable command loop is met, command processor unit 11 processes the repeatable command loop in command register 14 at the second frequency. If the condition is not met, command processor 11 controls command selecting unit 12 to retrieve a subsequent program command from command memory 13 so as to process subsequent program command at the first frequency.

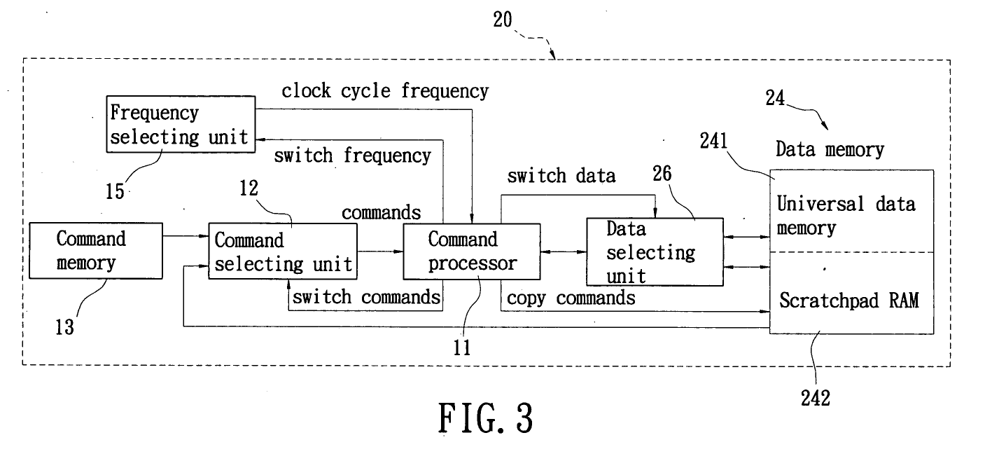

FIG. 3 is a block diagram of a microcontroller according to a second embodiment of present invention. Microcontroller 20 is used to speed up the execution of the repeatable commands, and includes a command processor 11, a command selecting unit 12, a command memory 13, a command register 14 and a frequency selecting unit 15. Frequency selecting unit 15 is controlled by command processor 11 to provide a first frequency and a second frequency as clock cycle frequency. The second frequency is higher than the first frequency. Command memory 13 is used to store a program command which is processed by command processor 11. The program includes at least one repeatable command loop which is commonly a subprogram.

The microcontroller further includes a data memory 24, including a universal data memory 241 and a scratchpad RAM 242. Universal data memory 241 is used to store data which will be accessed for processor 11 to process. Scratchpad RAM 242 is used to store data which will be accessed for processor 11 to process, or temporarily store the repeatable command loop for command processor 11 to process. When scratchpad RAM 242 is used to temporarily store the command loop, it will not allow access by command processor 11. Data memory 24 has an access speed higher than command memory 13. Command selecting unit 12 is connected to command memory 13 and scratchpad RAM 242. Under the control of command processor 11, command selecting unit 12 would retrieve the program command from command memory 13, or retrieve a command of the repeatable command loop from scratchpad RAM 242 for command processor 11 to process. Data selecting unit 26 is connected to universal data memory 241 and scratchpad RAM 242. Under the control of command processor 11, data selecting unit 26 would access universal data memory 241 or scratchpad RAM 242.

Command processor 11 is connected to data selecting unit 26, scratchpad RAM 242, command selecting unit 12 and frequency selecting unit 15. Command processor 11 controls the command selecting unit to receive the program command or the repeatable command loop. When command processor 11 needs to repeatedly executes the repeatable command loop, command selecting unit 12 retrieves the repeatable command loop from scratchpad RAM and control the frequency selecting unit to provide the second frequency to process the repeatable command loop. While the command processor has no need to repeatedly execute the repeatable command loop, the command of the repeatable command loop is copied to scratchpad RAM 242. When the last command of the repeatable command loop is processed in command processor 11, it is detected whether execution of the repeatable command loop continues. If the execution of the repeatable command loop continues, then frequency selecting unit 15 switches the first frequency to the second frequency and command selecting unit 12 retrieves command of the repeatable command loop from scratchpad RAM 242 so as to process the repeatable command loop at the second frequency. If the execution of the repeatable command loop ends, then command processor 11 controls command selecting unit 12 to retrieve the subsequent program command from command memory 13 and processes the subsequent command at first frequency; and, the repeatable command loop stored in scratchpad RAM 242 will be discarded.

The ways that command processor 11 detects the starting point and the end point of the repeatable command loop and whether the execution of the repeatable command loop continues or not are the same as the embodiment referred to in FIG. 2, and therefore would be omitted here below.

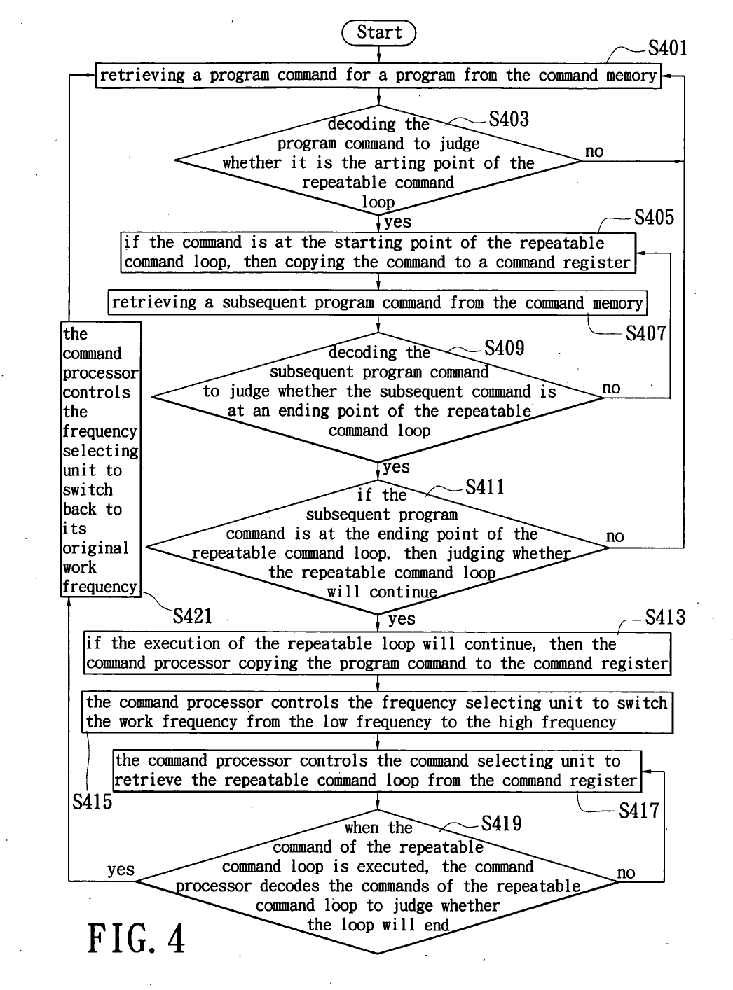

FIG. 4 is a flow chart of a method of speeding up the execution of repeatable commands according to one embodiment of present invention. The method includes retrieving a program command for a program from command memory 13 (Step S401). The program command is decoded to detect whether it is the starting point of the repeatable command loop (Step S403). If the command is not at the starting point of the repeatable command loop, then go back to Step S401. If the command is at the starting point of the repeatable command loop, then copy the command to a command register (Step S405).). Command processor 11 retrieves a subsequent program command from command memory 13 (Step S407) The subsequent program command is decoded to detect whether the subsequent command is at an end point of the repeatable command loop (Step S409). If the subsequent program command is not at the end point of the repeatable command loop, then go back to Step S405. If the subsequent program command is at the end point of the repeatable command loop, then detect whether the repeatable command loop will continue (Step S411). If the execution of the repeatable loop will end, then go back to Step S401. If the execution of the repeatable loop will continue, then command processor 11 copies the program command to command register 14 (Step S413). Command processor 15 controls frequency selecting unit 15 to switch the clock cycle frequency from the low frequency (first frequency) to the high frequency (second frequency) (Step S415). Command processor 11 controls command selecting unit 12 to retrieve the repeatable command loop from command register 14 (Step S417).

When the command of the repeatable command loop is executed, command processor 11 decodes the commands of the repeatable command loop to detect whether the loop will end (Step 419). If YES, then go to Step S417. If NO, then command processor 11 controls frequency selecting unit 15 to switch back to its original clock cycle frequency (Step S421). Afterward, go back to Step S401.

Command register 14 above can be scratchpad RAM 242 of data memory 24 as shown in the embodiment referred to in FIG. 3.

In light of above, the microcontroller retrieves the commands by the command memory since it starts the command execution. The command memory clock cycle is slower. When the repeatable command loop is executed, the repeatable command loop is stored in the command register (or scratchpad RAM) which runs more quickly than the command memory. Therefore, when the execution of the repeatable command loop continues, the subsequent command is retrieved from the command register or the scratchpad RAM and then processed at higher frequency, thereby achieving speeding up the execution of the repeatable commands.

It should be apparent to those skilled in the art that the above description is only illustrative of specific embodiments and examples of present invention. Present invention should therefore cover various modifications and variations made to the herein-described structure and operations, provided that they fall within the scope of the present invention as defined in the following appended claims.

What is claimed is:

1. A microcontroller able to speed up the execution of repeatable commands, comprising
a command memory used to store a program to provide a program command, wherein the program includes at least a repeatable command loop;
a command register used to temporarily store the repeatable command loop;
a command selecting unit connected to the command memory and the command register so that the command memory retrieves the program command or retrieves the repeatable command loop from the command register;
a frequency selecting unit used to switch between a first frequency and a second frequency, wherein the second frequency is higher than the first frequency; and
a command processor connected to the command register, the command selecting unit, and the frequency selecting unit, wherein the command processor copies the repeatable command loop to the command register so as to control the command selecting unit to retrieve the program commands or the repeatable command loop;
wherein when the command processor is to repeatedly execute the repeatable command loop, the command selecting unit is made to retrieve the repeatable command loop from the command register, and the frequency selecting unit provides the second frequency to process the repeatable command loop; and
wherein when the command processor has no need to repeatedly execute the repeatable command loop, the command selecting unit retrieves the program command from the command memory and the frequency selecting unit provides the first frequency to process the program command.

2. The microcontroller of claim 1, wherein the repeatable command loop includes
a starting point, defined at the start of the repeatable command loop and used for the command processor to identify the starting position of the repeatable command loop; and
an end point, defined at the end of the repeatable command loop for the command processor to identify the end position of the repeatable command loop.

3. The microcontroller of claim 2, wherein the end point of the repeatable command loop further includes a repeatable command loop assessment command for the command processor unit to detect whether the execution of the repeatable command loop continues.

4. The microcontroller of claim 1, wherein the command register has higher access speed than the command memory.

5. The microcontroller able to speed up repeatable commands, comprising:
a command memory used to store a program to provide a program command, wherein the program includes at least a repeatable command loop;
a data memory, including
a universal data memory used to store data; and
a scratchpad RAM used to store data or temporarily store the repeatable command loop;
a command selecting unit connected to the command memory and the command register so that the command memory retrieves the program command or so that the repeatable command loop is retrieved from the command register;
a frequency selecting unit used to select between a first frequency and a second frequency, wherein the second frequency is higher than the first frequency; and
a command processor connected to the scratchpad RAM, the command selecting unit, and the frequency selecting unit so that the repeatable command loop can be copied to the scratchpad RAM, thereby controlling the command selecting unit to receive the program command or the repeatable command loop;
wherein when the command processor has to repeatedly executes the repeatable command loop, the command selecting unit retrieves the repeatable command loop from the scratchpad RAM and causes the frequency selecting unit to provide the second frequency to process the repeatable command loop; and when the command processor has no need to repeatedly execute the repeatable command loop, the command selecting unit retrieves the program command from the command memory and the frequency selecting unit so that the frequency selecting unit provides the first frequency to process the program command.

6. The microcontroller of claim 5, further comprising a data selecting unit, wherein when the scratchpad RAM is used to store data, the command processor-control the data selecting unit to retrieve data from the universal data memory or the scratchpad RAM to execute data access.

7. The microcontroller of claim 5, wherein the repeatable command loop comprising:
a starting point, defined at the start of the repeatable command loop and used for the command processor to identify the starting position of the repeatable command loop; and
an end point, defined at the end of the repeatable command loop for the command processor to identify the end position of the repeatable command loop;
wherein when the command processor process a program, the repeatable command loop can be identified and stored in the command register.

8. The microcontroller of claim 7, wherein the end point of the repeatable command loop further includes a repeatable command loop assessment command for the command processor unit to detect whether the execution of the repeatable command loop continues.

9. The microcontroller of claim 5, wherein the command register has higher access speed than the command memory.

10. A method of speeding up execution of repeatable commands, comprising
(a) retrieving a program command for a program from a command memory, wherein the program includes at least one repeatable command loop;
(b) processing the program command and detect whether it is a starting point of the repeatable command loop;
(c) if the command is at the starting point of the repeatable command loop, then copy the command to a command register;
(d) retrieving a subsequent program command;
(e) processing the subsequent program command and detect whether the subsequent command is at the end point of the repeatable command loop; if the subsequent program command is not at the end point of the repeatable command loop, then copying the subsequent command and going back to step (d);
(f) if the subsequent program command is at the end point of the repeatable command loop, then detect whether the execution of the repeatable command loop continues;
(g) if the execution of the repeatable loop continues, then copy the program command to the command register and switch the clock cycle frequency from the first frequency to the second frequency, wherein the second frequency is higher than the first frequency; and
(h) retrieving the repeatable command loop from the command register and executing the repeatable command loop at second frequency.

11. The method of claim 10, further comprising the step of detecting whether the execution of the repeatable command loop ends; if YES, then switch the clock cycle frequency to the first frequency and going to step (d); if NO, then the command register retrieves the repeatable command loop which is executed at the second frequency.

12. The method of claim 10, wherein the step (b) further comprises the retrieval of a subsequent command from the command memory, if the program command is not at the starting point of the repeatable command loop.

13. The method of claim 10, wherein the step (f) further comprises the retrieval of a subsequent command from the command memory, if the execution of the repeatable command loop ends.

14. The method of claim 10, wherein the repeatable command loop includes a starting point, defined at the start of the repeatable command loop and used for the command processor to identify the starting position of the repeatable command loop; and an end point, defined at the end of the repeatable command loop and used for the command processor to identify the end position of the repeatable command loop.

15. The method of claim 14, wherein the end point of the repeatable command loop further includes a repeatable command loop assessment command for the command processor unit to detect whether the execution of the repeatable command loop continues.

16. The method of claim 10, wherein the command register has higher access speed than the command memory.
